(19) United States
(12) Patent Application Publication
(10) Pub. No.: US 2008/0298305 A1
(43) Pub. Date: Dec. 4, 2008

(54) COMMUNICATION SYSTEM, OUTPUT DEVICE, INPUT DEVICE AND WIRELESS COMMUNICATION METHOD

(75) Inventor: Toru Nakamura, Tochigi (JP)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/037,277

(22) Filed: Feb. 26, 2008

(30) Foreign Application Priority Data
Feb. 26, 2007 (JP) 2007-045980

(51) Int. Cl. H04Q 7/00

(52) U.S. Cl. 370/328

(57) ABSTRACT

The objective of the invention is to enable easy recognition of a wireless communication device at the connection destination and to enable connection when wireless connection is newly made between wireless communication devices. On display 302 of digital television receiver 3, image pattern 301 obtained by converting the SSID and WEP key or other connection information is displayed. Digital still camera 4 takes a picture for image pattern 301. Digital still camera 4 performs re-conversion for the picked-up image pattern 301 to the connection information, and the connection information is used for wireless connection to digital television receiver 3.

This application claims priority of Japanese Patent Application No. 2007-045980, filed 26 Feb. 2007.

### FIELD OF THE INVENTION

The invention relates to a type of wireless communication system, a type of output device, a type of input device, and a wireless communication method for making a new wireless connection between devices that perform wireless communication (hereinafter to be referred to as wireless communication devices).

### BACKGROUND

When a new wireless connection is to be made between wireless communication devices, mutual recognition of the counterpart wireless communication device is necessary. When a wireless network is used as the communication medium, first, it is necessary to subscribe to the wireless network. In addition, it is necessary to obtain the information for recognizing the wireless communication device of the counterpart. Consequently, if connection is made to a wireless network without a connection history, a certain means for input of such information is required.

When connection of a wireless communication device is made to a wireless LAN, a type of wireless network, according to IEEE 802.11a/b/g, Bluetooth, UWB (Ultra Wide band), or other wireless communication standards, wireless communication is performed between the wireless LAN access point and the wireless communication device as a wireless LAN client.

For example, when wireless communication is performed according to IEEE802.11a/b/g, the wireless LAN access point and the wireless LAN client should have the same SSID (Service Set ID). Also, in order to strengthen the security, WEP (Wired Equivalent Privacy) and WPA (Wi-Fi Protected Access), or another encryption technology may be used. When such encryption technology is used, there should be a common WEP key.

Such wireless LAN access point and wireless LAN client perform wireless communication based on such communication connection information. If there is no common connection information, communication is impossible even if there is a wireless communication function based on the same wireless communication standard.

Also, for camera-equipped cell phones, a scheme has been proposed in which a barcode is picked-up, and various functions are set corresponding to the barcode (for example, see: Japanese Kokai Patent Application No. 2003-289350, sections [0013]-[0016], FIG. 5).

When wireless communication is to be made between wireless communication devices that have not been previously mutually connected, it is necessary to input common connection information using a certain scheme. In a conventional wireless communication device, such information may be input by key manipulation of the user, or information is exchanged via equipment having connection information recorded in it and by means of wire connection.

However, when a user performs input manually, the operation is complicated and errors may occur. In addition, for small wireless communication devices, the input means may be limited to a manual input scheme.

In the method of information exchange via a device having connection information recorded in it or with wire connection, connection must occur by means of cables, etc. However, for small wireless communication devices, since the connectors are also smaller, the operation is more difficult. If the connector for connection could be eliminated, it would contribute significantly to a reduction in size and a reduction in the cost of wireless communication devices.

As explained above, there is a demand for development of a type of wireless communication system, a type of output device, a type of input device and a wireless communication method that can easily recognize and connect to the wireless communication system of the connection destination when a new wireless connection is to be made between wireless communication devices.

### SUMMARY OF THE INVENTION

In order to realize the aforementioned objective, the invention provides a type of wireless communication system characterized by the fact that it has an output device, which contains a first wireless communication part that stores connection information shared by devices that perform wireless communication and performs wireless communication based on the connection information, a first control part that converts the connection information to a connection information pattern of voice and/or image, and an output part that outputs such connection information pattern, and an input device, which contains an input part that inputs voice and/or image, a second control part that analyzes such input voice and/or image and, when it is judged that such input voice and/or image may be the connection information pattern, reconverts such connection information pattern to a connection information candidate, and a second wireless communication part that performs test wireless communication based on such connection information candidate.

For the wireless communication system of the invention, the following scheme is preferred: it has a wireless network access device that performs the following operation: the wireless communication emitted from such output device is received; when it is judged that the received wireless communication has been performed based on such connection information, such output device is connected to the wireless network, and a test wireless communication of such input device is received; and, when it is judged that such received wireless communication has been performed based on such connection information, such input device is connected to the wireless network.

For the wireless communication system of the invention, the following scheme is preferred: such output device receives the test wireless communication of such input device, and, when it is judged that the received wireless communication has been performed based on such connection information, wireless communication is performed with such input device.

For the wireless communication system of the invention, the following scheme is preferred: at a prescribed timing, such first control part refreshes such connection information, sets such refreshed connection information in such first wireless communication part, and converts such refreshed connection information to the connection information pattern.

For the wireless communication system of the invention, the following scheme is preferred: such connection information contains a wireless communication standard on which the device for performing such wireless communication is based.

For the wireless communication system, it is preferred that such connection information contain an SSID and WEP key.

Also, for the wireless communication system of the invention, it is preferred that such connection information contain the IP address of such output device.

Also, for the wireless communication system of the invention, the following scheme is preferred: such output device is a digital television receiver, such connection information pattern is an image pattern, and such input device is an image pickup device.

For the wireless communication system of the invention, the following scheme is preferred: such output device is a printer, such connection information pattern is an image pattern, and such input device is an image pickup device.

For the wireless communication system of the invention, it is preferred that such printer have a storage part that stores the operating condition, and that such image pattern also contain the operating condition of such printer.

For the wireless communication system of the invention, it is preferred that such connection information be represented by the shape, color, and/or pattern of such image pattern.

For the wireless communication system of the invention, it is preferred that such image pattern be a two-dimensional code.

In addition, the invention provides a type of output device characterized by the following facts: the output device is for performing wireless communication with other wireless communication devices based on connection information shared by devices that perform wireless communication; and it has a wireless communication part that stores such connection information and performs wireless communication based on such connection information, a control part that converts such connection information to a connection information pattern of voice and/or image, and an output part that outputs such connection information pattern.

Also, the invention provides a type of input device characterized by the following facts: the input device is for performing wireless communication with other wireless communication devices based on connection information shared by devices that perform wireless communication; and it has an input part that inputs voice and/or image, a control part, which analyzes such input voice and/or image, and when it is judged that such input voice and/or image may be a connection information pattern, re-converts such connection information pattern to a connection information candidate, and a wireless communication part that performs test wireless communication based on such connection information candidate.

Also, the invention provides a wireless communication method characterized by the following facts: this wireless communication method is for a wireless communication system that contains an output device, which performs wireless communication with other wireless communication devices based on connection information shared by devices that perform wireless communication, and an input device, which performs wireless communication with other wireless communication devices based on such connection information; according to this wireless communication method, such output device converts such connection information stored in such output device to a connection information pattern of voice and/or image, outputs such connection information pattern, and performs wireless communication based on such connection information; and such input device has the voice and/or image input and analyzes the input voice and/or image, and when it is judged that such input voice and/or image may be the connection information pattern, re-converts such connection information pattern to a connection information candidate, and performs test wireless communication based on such connection information candidate.

### BRIEF DESCRIPTION OF THE DRAWINGS

FIG. 1 is a diagram illustrating an example of the configuration of a wireless communication system.

FIG. 2 is a diagram illustrating an example of connection of a DSC and DTV by a wireless LAN in Embodiment 1 of the invention.

FIG. 3 is a block diagram illustrating an example of the configuration of a DTV.

FIG. 4 is a diagram illustrating an example of the configuration of the software of the control part of a DTV.

FIG. 5 is a block diagram illustrating an example of the configuration of DSC.

FIG. 6 is a block diagram illustrating an example of the configuration of the software of the control part of a DSC.

FIG. 7 is a diagram illustrating an example of the flow chart for treatment by the control part of a DTV.

FIG. 8 is a diagram illustrating an example of the flow chart for treatment by the control part of a DSC.

FIG. 9 is a diagram illustrating an example of connection of a DSC and a set-top box by means of a wireless LAN pertaining to Embodiment 2 of the invention.

FIG. 10 is a diagram illustrating an example of connection of a DSC and a wireless LAN access point by a wireless LAN pertaining to Embodiment 3 of the invention.

FIG. 11 is a diagram illustrating an example of connection of a DSC to a wireless LAN in Embodiment 4 of the invention.

FIG. 12 is a flow chart illustrating the treatment for change in the WEP key in a short period of time.

FIG. 13 is a diagram illustrating an example of connection of a printer and a DSC by means of a wireless LAN in Embodiment 6 of the invention.

FIG. 14 is a graph illustrating the power consumption required for connection of a DSC to a wireless LAN when the DSC has no information pertaining to the operating condition of the printer.

FIG. 15 is a graph illustrating the power consumption required for connection of a DSC to a wireless LAN when the DSC has information pertaining to the operating condition of the printer.

FIG. 16 is a block diagram illustrating an example of the configuration of a printer.

FIG. 17 is a diagram illustrating an example of sending of connection information using a voice pattern pertaining to Embodiment 7 of the invention.

FIG. 18 is a block diagram illustrating an example of the configuration of a voice output device.

FIG. 19 is a block diagram illustrating an example of the configuration of a voice recording device.

### DETAILED DESCRIPTION OF EXAMPLE EMBODIMENTS

As explained above, the invention provides a type of wireless communication system, a type of output device, a type of input device, and a wireless communication method that can easily recognize the wireless communication device of the connection destination when a new wireless connection is made between wireless communication devices.

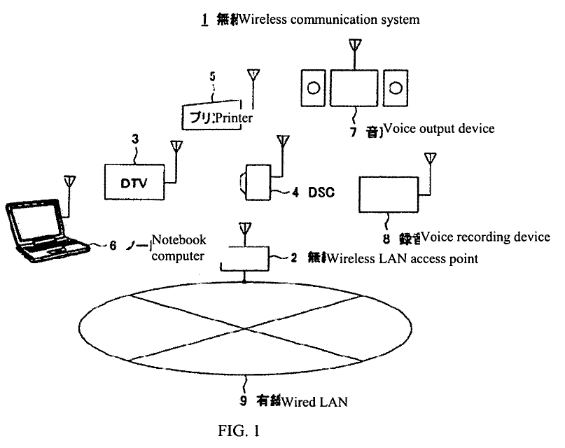

FIG. 1 is a diagram illustrating an example of the configuration of a wireless communication system. Wireless communication system 1 has the following parts: wireless LAN access point 2, digital television receiver 3 (hereinafter to be referred to as a DTV), digital still camera 4 (hereinafter to be referred to as a DSC), printer 5, notebook computer 6, voice output device 7, and voice recorder 8.

Such DTV 3, DSC 4, printer 5, notebook computer 6, voice output device 7, and voice recorder 8 are wireless LAN clients having wireless communication functions, and are connected to each other via wireless LAN access point 2. Such DTV 3, printer 5, notebook computer 6 and voice output device 7 are permanently connected to the wireless LAN. On the other hand, for example, DSC 4 is temporarily connected to the wireless LAN when, e.g., an image is to be displayed on DTV 3, and voice recorder 8 is temporarily connected to the wireless LAN when, e.g., voice is to be output from such voice output device 7.

That is, DTV 3, printer 5, notebook computer 6 and voice output device 7 are examples of output devices of the invention, DSC 4 and voice recorder 8 are examples of input devices of the invention, and wireless LAN access point 2 is an example of the wireless network access device of the invention. Also, DTV 3 is an example of the digital television receiver of the invention, and DSC 4 is an example of the image pickup device of the invention.

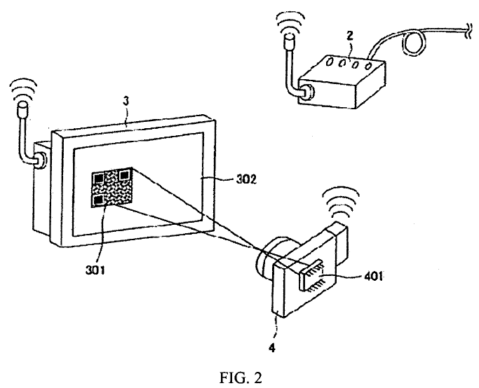

FIG. 2 is a diagram illustrating an example of connection between a DSC and DTV by wireless LAN in Embodiment 1 of the invention. FIG. 2 shows wireless LAN access point 2, DTV 3, image pattern 301, display 302, DSC 4, and image pickup element 401. The same keys are adopted in FIGS. 1 and 2. Such wireless LAN is based on the IEEE802.11 system wireless communication standard.

In order to display the image of DSC 4 on DTV 3, it is necessary to connect DSC 4 and DTV 3. However, as DSC 4 is downsized, the connector is also downsized, wiring connection is difficult. Here, in many DTVs 3, there is a network connection function by means of TCP/IP, and the IEEE802.11 system wireless LAN is usually used in making the wireless connection. Here, such wireless LAN is used for connection of DSC 4 and DTV 3.

In the configuration of a wireless LAN, there is an infrastructure mode in which communication is performed via wireless LAN access point 2, and there is an ad hoc mode in which one-to-one direct communication is performed between various wireless communication devices. Here, when DTV 3 is connected to a wireless LAN for internet connection, wireless LAN access point 2 that also acts as the modem and router for internet connection is present in the wireless LAN. In the present embodiment, it is assumed that connection is performed in the infrastructure mode.

When communication is performed between wireless communication devices by means of a wireless LAN, they should have a common SSID. Also, since communication is usually performed with encryption, there should be a common WEP key. Here, wireless LAN access point 2 and DTV 3 have a common SSID and WEP key, and DTV 3 is connected to the wireless LAN via wireless LAN access point 2. In this state, when DSC 4 is to be newly connected to the wireless LAN, there are problems in the method for inputting the SSID and WEP key as the connection information for connecting DSC 4 to the wireless LAN. In the following, the action of acquisition of the connection information of SSID and the WEP key and of safe connection to the wireless LAN is referred to as association.

In the present embodiment, in order to input connection information to DSC 4, image pattern 301 is used. Image pattern 301 converted to connection information is displayed on display 302 of DTV 3, and when image pattern 301 is picked-up by DSC 4, the connection information is sent from DTV 3 to DSC 4. Such DSC 4 re-converts image pattern 301 to the connection information, and this connection information is used to associate to the wireless LAN.

When the user wants to display an image of DSC 4 on display 302 of DTV 3, a remote controller or the like not shown in the figure is used to set an image transfer mode for DTV 3. Such DTV 3 converts the connection information pertaining to the wireless LAN being associated with into, e.g., a two-dimensional barcode for display on display 302 of DTV 3.

The user performs a switching operation for DSC 4 to switch DSC 4 to the image pickup mode, and image pattern 301 displayed on display 302 of DTV 3 is picked-up. In DSC 4, there is a CCD or another image pickup element 401, which is used to retrieve image pattern 301 just as in a normal image pickup operation. Such DSC 4 re-converts image pattern 301 to retrieve the connection information contained in it. Since DSC 4 has a wireless LAN function, it is possible to associate with the wireless LAN by using the retrieved connection information, just as in the case of DTV 3.

Once associated with the wireless LAN, for example, DHCP protocol, AutoIP protocol or the like is used to retrieve the IP address. Then, for example, it is possible to perform device recognition by mDNS packets and transfer of the image taken by PTP-IP (Picture Transfer Protocol over TCP/IP networks). Also, the IP address of DTV 3 may be contained in image pattern 301. In this way, it is also possible for DSC 4 to directly contact DTV 3.

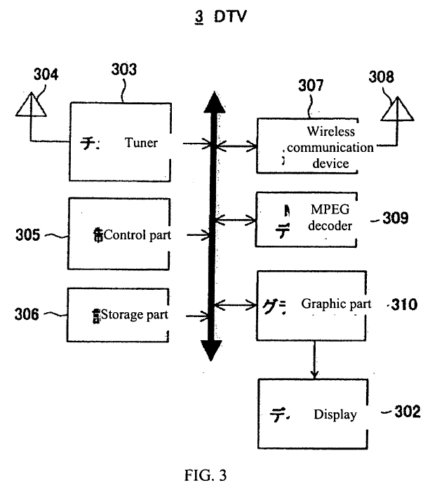

FIG. 3 is a block diagram illustrating an example of the configuration of a DTV. Here, DTV 3 has tuner 303, antenna 304 for the tuner, control part 305, storage part 306, wireless communication part 307, antenna 308 for the wireless communication part, MPEG decoder 309, graphic part 310, and display 302. The same keys are adopted in FIGS. 2 and 3.

Such tuner 303 selects the signal with a prescribed bandwidth (channel) from the television signal received with antenna 304 for the tuner, and outputs a bit stream encoded according to MPEG or another standard. MPEG decoder 309 decodes the bit stream to image data. Such graphic part 310 contains a graphic card and a display controller, and it converts the decoded image data to an analog signal and sends it to display 302. Such display 302 displays the image. Here, MPEG is an example, and the image may be encoded according to H.264 or another standard.

Such control part 305 has a CPU and a memory not shown in the figure, and an OS operates on the CPU. When control part 305 controls wireless communication part 307, graphic part 310, and other hardware, the device driver contained in the OS is used.

For example, storage part 306 is composed of a hard disk, flash memory or the like, and it allows rewrite. Such storage part 306 stores the program, OS, etc. for converting to image pattern 301.

Such wireless communication part 307 has antenna 308 for the wireless LAN connected to it, and it is used in connection with the wireless LAN. Such wireless communication part 307 contains an incorporated CPU and firmware not shown in the figure. For connection between DTV 3 and the wireless LAN, the firmware contained in wireless communication part 307 controls, and a device driver for the wireless LAN contained in the OS controls the firmware.

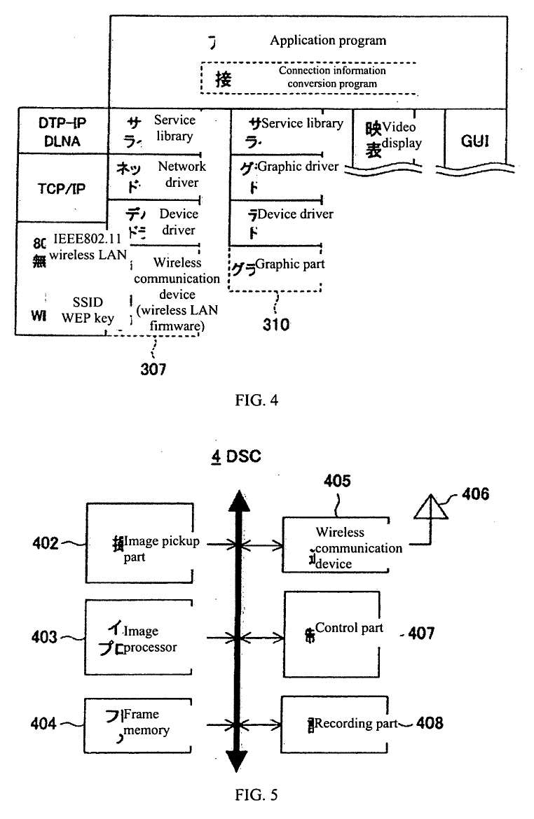

FIG. 4 is a diagram illustrating an example of the configuration of the software of the control part of a DTV. The same keys are adopted in FIGS. 3 and 4. For a wireless LAN, because it is usually used as a network by means of TCP/IP, it is located in the lower layer of the network driver, and it works as a physical layer from the viewpoint of the network driver. Because the communication protocol of the network is complicated, usually, instead of direct access by the application program, a certain type of library is used for access. In the example shown in FIG. 4, DTV 3 has a library for internet connection and connection to DSC 4. For example, assuming that the PTP-IP protocol used for connecting to DSC 4, there is a library for PTP-IP. Also, if the protocol of DLNA (Digital Living Network Alliance) is used for connection to DSC 4 or for connection to another device, there is a library of DLNA.

The SSID and WEP key as the necessary information for association with a wireless LAN are usually used in the firmware of the wireless LAN or the device driver layer of the wireless LAN. On the other hand, in the present embodiment, a connection information conversion program, a type of application program of DTV 3, requires the SSID and WEP key. In such case, the connection information conversion program contacts the lower layer via a device driver to retrieve the SSID and WEP key.

Such graphic part 310 of DTV 3 has a graphic plane overlaying the top of the plane that displays the broadcast image. In the present embodiment, image pattern 301 is displayed on such graphic plane. Just as in the case of connection to the wireless LAN, display on the graphic plane is also performed via a library and device driver.

When the user demands display of an image picked-up by DSC 4, for example, the user manipulates a remote controller to control the application of DTV 3 by means of a graphic user interface GUI. The application of DTV 3 retrieves the SSID and WEP key, the connection information to the wireless LAN, via the device driver, and converts them to a two-dimensional barcode by means of a connection information conversion program as a type of application program. The treatment of conversion to the two-dimensional barcode is performed only once when the user performs the operation of connection of DSC 4. Also, it is a relatively light treatment, so it is carried out by means of software of the CPU in control part 305 in the present embodiment. The two-dimensional barcode (image pattern 301) is depicted on the graphic plane for display on display 302. The two-dimensional barcode is continuously displayed until DTV 3 has checked that DSC 4 is associated with the wireless LAN. However, one may also adopt a scheme in which the display ends earlier if the user operates a remote controller or the like.

Here, control part 305 is an example of the first control part of the invention, 302 is an example of the output part of the invention, and wireless communication part 307 is an example of the first wireless communication part of the invention.

FIG. 5 is a block diagram illustrating an example of the configuration of a DSC. Here, DSC 4 has the following parts: image pickup part 402, image processor 403, frame memory 404, wireless communication part 405, antenna 406 for the wireless communication part, control part 407, and recording part 408.

Such image pickup part 402 contains a CCD or another image pickup element 401. Such image pickup element 401 photoelectrically converts the light incident on the image pickup part. Such image processor 403 uses frame memory 404 as the operating region in forming the photoelectrically converted data into an image.

Such control part 407 has a CPU and a memory not shown in the figure, and it actuates the connection information re-conversion program or another application program work. Such recording part 408 contains a flash memory or the like for recording the image formed by image processor 403. Such wireless communication part 405 is connected to antenna 406 for the wireless LAN, and it is used for connection to the wireless LAN. Just like wireless communication part 307 of DTV 3, wireless communication part 405 also contains a CPU and firmware not shown in the figure. The firmware contained in wireless communication part 405 controls the connection between DSC 4 and the wireless LAN, and a device driver for the CPU of control part 407 controls its firmware.

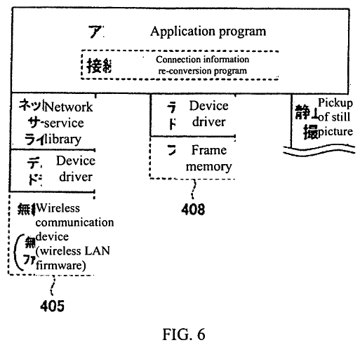

FIG. 6 is a diagram illustrating an example of the configuration of the software of the control part of a DSC. The same keys are adopted in FIGS. 5 and 6. Usually, the performance of the CPU and memory contained in control part 407 of DSC 4 is lower than that of the CPU and memory contained in control part 305 of DTV 3. Consequently, in the present embodiment, the layer of the software is not very deep. However, the same configuration as that of control part 305 of DTV 3 may be adopted.

When image pattern 301 is used to set the SSID and WEP key in wireless communication part 405, the connection information re-conversion program judges whether there is any possibility that the image made by image processor 403 is image pattern 301. If it is possible that such image is image pattern 301, the image is re-converted to a candidate of connection information. When a two-dimensional barcode is used in image pattern 301, since the image is a still image and a black and white binary image, the treatment is relatively light. Consequently, re-conversion is possible by means of software. However, a restriction to software is not a necessity. When a moving picture is used in image pattern 301, re-conversion using hardware may be more appropriate.

When re-conversion using the software is performed, the image formed by image processor 403 is retrieved via image processor 403 into the memory in control part 407 by means of a device driver. The retrieved image is analyzed by the connection information reconversion program after binary formation treatment, and the contained connection information is retrieved. Here, the retrieved connection information is the SSID and WEP key converted in DTV 3. It is set via the network service library and the device driver in wireless communication part 405. Such wireless communication part 405 uses such SSID and WEP key in trying to associate with the wireless LAN.

In the treatment for retrieval of the connection information after re-conversion of image pattern 301, the operation may fail due to distortion and other noise contained in the image caused by an inappropriate distance and inclination, uneven luminance, etc. Consequently, in few cases, the operation from retrieval of an image to obtaining connection information can be finished in a single round. When it is judged that acquisition of the connection information failed due to rejection of the connection by wireless LAN access point 2, the state of failure of the connection information is notified to the user, so the user can adjust the distance and angle and retake the picture.

However, if too much time is required to get the correct connection information, the user has an unpleasant feeling. In order to prevent this problem, several methods may be adopted. According to one method, the conversion algorithm of image pattern 301 is strengthened to increase the acquisition rate of the connection information. According to another method, the response to the user is quickened so the user is asked to adjust the pickup conditions sooner. Because DSC 4 has a high-precision exposure mechanism, high resolution lens and multi-pixel image handling ability for taking beautiful pictures, it is possible to use a high-grade conversion algorithm. On the other hand, efforts have been made to improve the package, etc. to facilitate picture taking, so that as the user changes the picture taking conditions, the connection information acquisition rate can be increased easily by means of user feedback.

Here, image pickup part 402 is an example of the input part in the invention, control part 407 is an example of the second control part of the invention, and control part 405 is an example of the second wireless communication part of the invention.

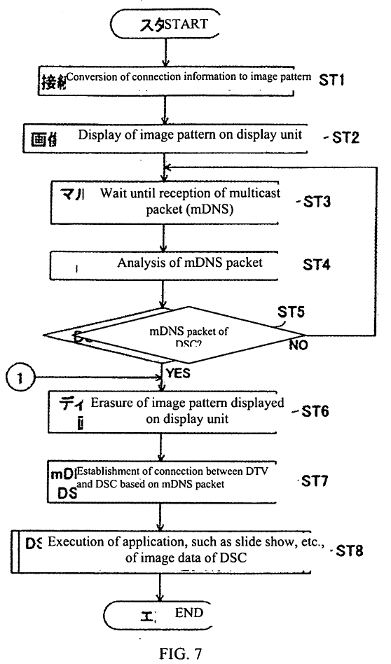

FIG. 7 is a diagram illustrating an example of the flow chart of the treatment in the control part of a DTV. When the user uses a remote controller to switch DTV 3 to the DSC mode, the treatment shown in FIG. 7 starts. First, the connection information of the SSID and WEP key is converted to image pattern 301 of a two-dimensional barcode (step ST1). As shown in FIG. 7, in step ST1, image pattern 301 is newly generated. However, one may also adopt a scheme in which DTV 3 is connected to the wireless LAN, and image pattern 301 is previously generated beforehand when the connection information of the SSID and WEP key is determined.

Then, image pattern 301 is displayed on the display unit (step ST2). Then, DSC 4 uses the connection information of the SSID and WEP key contained in image pattern 301 to notify the state of association with the wireless LAN. Consequently, reception of an mDNS packet that is multicast here starts (step ST3). As shown in FIG. 7, DSC 4 uses the mDNS packet to exploit the algorithm of the mDNS obtained by multi-casting its own service information. However, by containing the IP address of DTV 3 in image pattern 301, this step may be omitted and a connection set between DSC 4 and DTV 3. In step ST3, the reception of mDNS packet starts. However, one may also adopt a scheme in which the mDNS packet is constantly received, and the DNS service information is continuously updated when the mDNS protocol is used.

When mDNS is in use, this protocol is also used in devices other than DSC 4. Consequently, an analysis is made to determine whether the received mDNS packet is that of DSC 4 (step ST4). If the received mDNS packet is a device other than DSC 4, the flow returns to step ST3, and stand-by occurs for reception of the mDNS packet of DSC 4 (step ST5). Here, although not shown in the figure, one may also adopt a scheme in which the user operates to leave the loop of ST3 to ST5 to terminate the DSC mode.

In the following, an explanation will be given regarding the judgment treatment on whether the mDNS packet received in step ST4 is that of DSC 4.

As a first example of judgment of DSC 4, there is the following method: the SSID and WEP key and other connection information are added to image pattern 301, and the keyword of the number, etc. is contained and the keyword is then used. Such DTV 3 converts the connection information of the SSID and WEP key, etc. and the keyword to image pattern 301. Such DSC 4 picks up image pattern 301 and obtains the connection information and keyword. Then, the keyword is mounted on the mDNS packet for transmission. DTV 3 that has received the mDNS packet judges whether the keyword contained in the received mDNS packet and the keyword that has been converted to image pattern 301 agree. As a result, it is possible to check whether the device that has sent the mDNS packet is DSC 4 that picks up the picture of image pattern 301.

As a second example, there is a method in which the information of yes/no of an image sensor by analysis of the mDNS packet is used. DSC 4 can detect the presence of the image server that can be displayed by analyzing the mDNS packet that has been received. Here, based on the mDNS packet sent by DSC 4, DTV 3 connects by means of the PTP/IP protocol to DSC 4 as the image server. When DSC 4 on the server side receives connection from DTV 3 as the client side, connection between the two sides is finished. When DSC 4 receives connection, DTV 3 can judge that the initially received mDNS packet is that from DSC 4.

Here, the first method has higher connection security than the second method.

When the mDNS packet is that of DSC 4, it is possible to detect the IP address and the service content of DSC 4 from the information contained in the mDNS packet. As shown in FIG. 7, because the protocol of PTP-IP is used for transmission of the image of DSC 4 to DTV 3, in the mDNS packet, it is described that DSC 4 has the server function of PTP-IP.

In the example shown in FIG. 7, the protocol of mDNS/PTP-IP is used. However, the invention is not limited to it. For example, while the UPnP protocol is used in the case of the protocol of DLNA, the HTTP packet that includes the equipment information is multicast in the UPnP protocol. Also, as another scheme, another protocol may be used for transfer of DTV 3 and DSC 4.

Because the connection of DSC 4 to the wireless LAN is known and image pattern 301 is not needed, DTV 3 erases image pattern 301 (step ST6). Then, connection between DTV 3 and DSC 4 is established (step ST7), and application of a slide show of the image data stored in DSC 4 is executed (step ST8). Also, as shown in FIG. 7, after erasure of image pattern 301 in step ST6, communication between DTV 3 and DSC 4 is established in step ST7. However, one may also adopt a scheme in which the order is reversed.

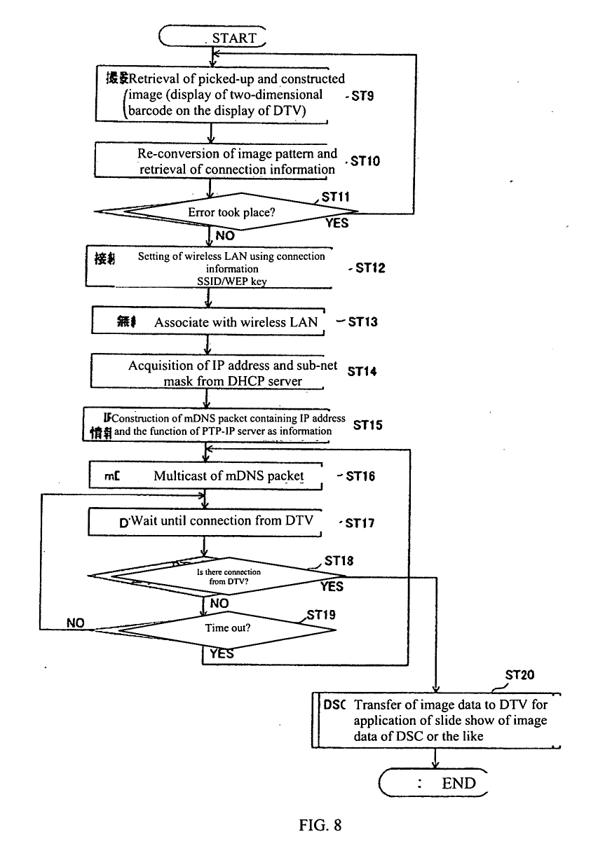

FIG. 8 is a diagram illustrating an example of a flow chart of the treatment in the control part of a DSC. When switching to the DTV mode occurs by means of user operation on the side of DSC 4, the treatment shown in FIG. 8 is started. In this case, just as in a conventional image pickup operation, electronic viewfinder display is also possible. Also, an image that has been taken and is formed by image processor 403 is retrieved into the memory in control part 407 (step ST9), image pattern 301 is re-converted, and the SSID, encryption key 7, and other connection information is retrieved (step ST10). It is not necessary for the user to pick up the image pattern 301 picture. When the user takes a picture of another object other than image pattern 301, or when the image pickup conditions are poor, such as an inclined angle, or the object is too small and out of focus, error occurs during conversion of image pattern 301. In this case, image pickup/retrieval (step ST9) and reconversion (step ST10) are repeated (step ST11). Also, although not shown in the figure, one may also adopt a scheme in which the user can release the DTV mode, and it is possible to leave the loop from step ST9 to step ST11.

Re-conversion of image pattern 301 is performed free of error, and although not shown in the figure, error checkup is performed for the retrieved connection information, and correct connection information is obtained, and the connection information is used to set the wireless LAN of DSC 4 (step ST12). In the example shown in FIG. 8, as the connection information, the SSID and WEP key are obtained. By setting the SSID and WEP key in the wireless LAN, it is possible to associate DSC 4 with the wireless LAN just like DTV 3 (step ST13). If a certain error takes place in step ST13, although not shown in the figure, it is possible to retry it automatically several times, and an alarm is displayed to the user.

After association with the wireless LAN, the IP address needed for the TCP/IP network is still undetermined. In the example shown in FIG. 8, a router integrated to wireless LAN access point 2 exists in the wireless LAN, and a DHCP server function is displayed here. With the DHCP server function, the IP address and the sub-net mask are acquired (step ST14). As a result, DSC 4 can communicate with DTV 3 by means of TCP/IP protocol. In the example shown in FIG. 8, a DHCP server is used in acquiring the IP address. However, one may also use AutoIP or another protocol to obtain the IP address. Here, when IPV6 is used, usually, there is an IPV6 address intrinsic to the device from the very beginning. Consequently, it is also possible to use this address.

After establishment of the TCP/IP network, in the example shown in FIG. 8, the mDNS protocol is used to notify the device connected to the TCP/IP network of the presence of DSC 4. By means of the mDNS protocol, the service information and the IP address are multicast as the mDNS packet. Consequently, the mDNS packet, which contains the IP address acquired in step ST14 and the function of the PTP-IP server as information, is formed (step ST15), and is multicast (step ST16).

Then, DSC 4 stands by for the connection from DTV 3 (step ST17). In the example shown in FIG. 8, an mDNS packet is used to send the service information of DSC 4 to the network, and it waits for DTV 3 to find the information. However, one may also adopt a scheme in which connection is directly made with DTV 3 as long as the IP address of DTV 3 is contained in image pattern 301. In the example shown in FIG. 8, the mDNS protocol is used in sending the service information, and PTP-IP is used in the transmission protocol of the image. However, one may also use DLNA or another UPnP or the like.

When the mDNS protocol is used, a DSC 4 performs up to the point of until sending the service information, so that in an actual transmission, it is necessary to wait for the connection from the side of DTV 3. However, since multicast uses a UDP packet, ack does not return, and whether it has reached DTV 3 is unclear. Consequently, usually, a reaction may not take place even after a prescribed time of waiting (step ST18, step ST19). In such case, it is believed that a certain error may exist, so the mDNS packet is multicast and resent (step ST16, step ST19). Although not shown in the figure, during the period of waiting for the connection from DTV 3, if the user performs a cancel operation, the loop from step ST16 to step ST19 is exited, and the DTV mode comes to an end. If the connection from DTV 3 is successful, according to the protocol of PTP-IP, the image data are transferred upon the request of DTV 3 for application of a slide show or the like of the image data of DSC 4 (step ST20). Although not shown in the figure, a network error may take place in such treatment series. In such case, it is preferred that a retry be made from the very beginning or at an appropriate site.

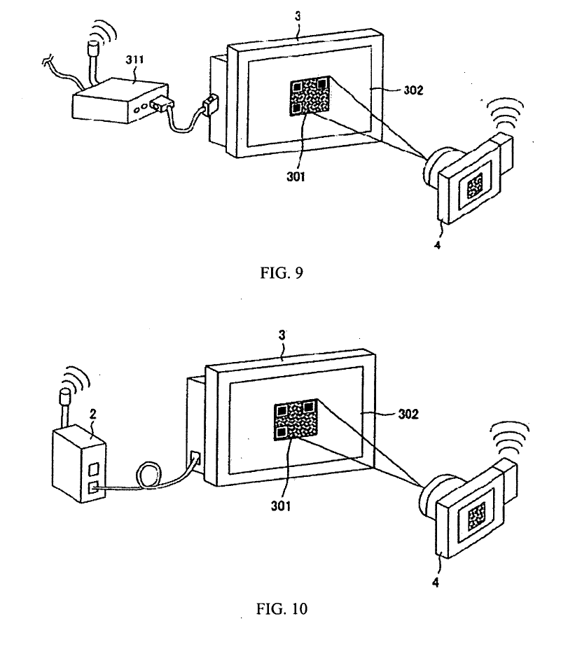

FIG. 9 is a diagram illustrating an example of connection of a DSC and a set-top box by wireless LAN in Embodiment 2 of the invention. FIG. 9 shows DTV 3, image pattern 301, display 302, set-top box 311 (hereinafter to be referred to as STB), and DSC 4. The same keys are adopted in FIGS. 2 and 9. In the present embodiment, DTV 3 has no wireless LAN function, while STB 311 has a wireless LAN function. In this case, STB 311 generates image pattern 301, and image pattern 301 is displayed on DTV 3 through HDMI or another image interface. As a result, just as in Embodiment 1, DSC 4 and STB 311 can be connected to a network. In this case, display 302 of DTV 3 displays image pattern 301. However, since STB 311 generates image pattern 301, it is only required that STB 311 and DSC 4 establish connection to the network, DTV 3 is simply a display device, and DTV 3 and DSC 4 need not be connected.

The control part of STB 311 not shown in the figure is an example of the first control part, and display 302 is an example of the output part of the invention. The wireless LAN connection portion of STB 311 not shown in the figure is an example of the first wireless communication system of the invention.

FIG. 10 is a diagram illustrating an example of connection of a DSC and a wireless LAN access point by means of a wireless LAN in Embodiment 3 of the invention. FIG. 10 shows wireless LAN access point 2, DTV 3, image pattern 301, display 302, and DSC 4. The same keys are adopted in FIGS. 1, 2 and 10. Even if DTV 3 does not have a wireless LAN function, when DTV 3 and wireless LAN access point 2 are connected by means of a wired LAN, it is possible to use the wired LAN to detect the connection information of wireless LAN access point 2 by DTV 3. As a result, DTV 3 generates image pattern 301 just as in Embodiment 1, and it is possible to display it on display 302.

Here, the control part of DTV 3 is an example of the first control part, display 302 is an example of the output part of the invention, and the wireless LAN connection part of wireless LAN access point 2 not shown in the figure is an example of the first wireless communication part of the invention.

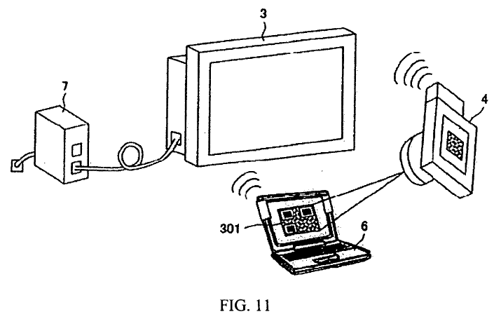

FIG. 11 is a diagram illustrating an example in which a DSC is connected to the wireless LAN in Embodiment 4 of the invention. FIG. 11 shows DTV 3, image pattern 301, DSC 4, notebook computer 6, and router 7. The same keys are adopted in FIGS. 1, 2 and 11. While DTV 3 is not connected to a wireless LAN, it is connected via router 7 to wired LAN 9. In the present embodiment, notebook computer 6 associated with a wireless LAN displays connection information as image pattern 301, and this is taken by DSC 4. DSC 4 uses image pattern 301 displayed on the display unit of notebook computer 6 to associate with the wireless LAN just like notebook computer 6. Although DTV 3 is not connected to the wireless LAN, wireless LAN access point 2 is connected to wired LAN 9, so DTV 3 and DSC 4 are present on the same TCP/IP network. Consequently, because the IP packet containing an mDNS packet from DSC 4 is delivered, it is possible to use the same protocol as that in Embodiment 1 to transfer an image from DSC 4 to DTV 3.

The processor of notebook computer 6 not shown in the figure is an example of the first control part of the invention, the display of notebook computer 6 is an example of the output part of the invention, and the wireless LAN connection part of notebook computer 6 not shown in the figure is an example of the first wireless communication part of the invention.

In such Embodiments 1-4, the SSID and WEP key and other connection information use fixed values. However, in consideration of security in a wireless LAN, they may also be changed on a regular basis. In Embodiment 1, DTV 3 also uses a wireless LAN used in network connection to transfer of images of DSC 4. When this wireless LAN is used for another purpose, the configuration of the wireless LAN, especially the WEP key, is laid open by image pattern 301, so there may be a problem in security.

In Embodiment 5, in order to improve security, a random number is used to refresh the network parameter in a short period of time. For example, while a common wireless LAN is used, only the WEP key is refreshed in a short period of time. In order to further improve the security, when connection is made to DSC 4, an ad hoc network or other network of another system is formed temporarily. DSC 4 performs wireless communication with DTV 3 on the network of the temporary other system, and it acquires the necessary connection information for associating with the wireless LAN of the infrastructure mode. Then, the connection information is used to make connection to wireless LAN access point 2 that works in the infrastructure mode using the connection information. Since association with the wireless LAN using image pattern 301 can be performed in a very short period of time, changes in the WEP key in a short period of time can be performed repeatedly.

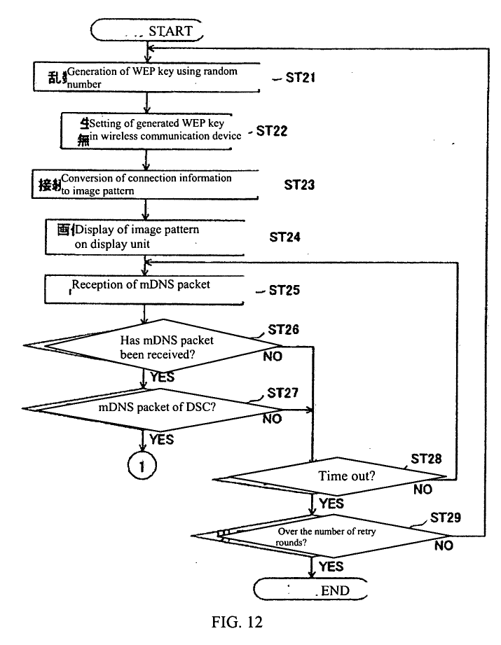

FIG. 12 is a flow chart illustrating a treatment in which the WEP key is changed in a short period of time. When the mode of transfer of image from DSC 4 to DTV 3 is entered, this treatment is started. First of all, a random number is used to generate a WEP key (step ST21). The newly generated WEP key should be used in DTV 3 itself, so the newly generated WEP key is set in wireless communication part 307 (step ST22). Just as in Embodiment 1, the WEP key or other connection information is converted to image pattern 301 (step ST23), and image pattern 301 is displayed on display 302 (step ST24). There is no problem with respect to the order for setting in DTV 3 itself (step ST22) and for conversion to image pattern 301 (step ST23). However, if setting in DTV 3 itself (step ST22) is not finished before display of image pattern 301 (step ST24), DSC 4 may be unable to cope if the speed is very high.

While image pattern 301 is displayed, reception of the multicast mDNS packet is started (step ST25). When an mDNS packet is not received for a prescribed time (step ST26), this is perceived to be time-out, and the mDNS packet reception standby loop is exited (step ST28). Then, the flow returns to step ST21 until a prescribed number of retry rounds is reached, and retrying occurs from regeneration of the WEP key (step ST29). Also, when mDNS is used, this protocol is also used in devices other than DSC 4. Consequently, when this protocol is used to receive mDNS (step ST26), judgment is made on whether the received mDNS packet is that of DSC 4 (step ST27). If the received mDNS packet is that of a device other than DSC 4, the flow returns to step ST25 (step ST28), and stand-by occurs until reception of an mDNS packet of DSC 4. When an mDNS packet of DSC 4 is received (step ST27), the same treatment as that of Embodiment 1 (FIG. 7) is performed.

The treatment of the judgment on whether the mDNS packet received in step ST27 is that of DSC 4 may be performed in the same way as in step ST4 shown in FIG. 7 above.

In such treatment, the time of display of a WEP key of constant value can be restricted. If the time of conversion of image pattern 301 is sufficiently short, it is possible to shorten the display time. Consequently, it is possible to improve network security. Also, if a restriction is also set on the number of rounds of re-generation and re-display of the WEP key (step ST29), security can be further improved.

As shown in FIG. 12, only the WEP key is generated on a random number basis. However, it is also possible to generate the SSID and other connection information on a random number base.

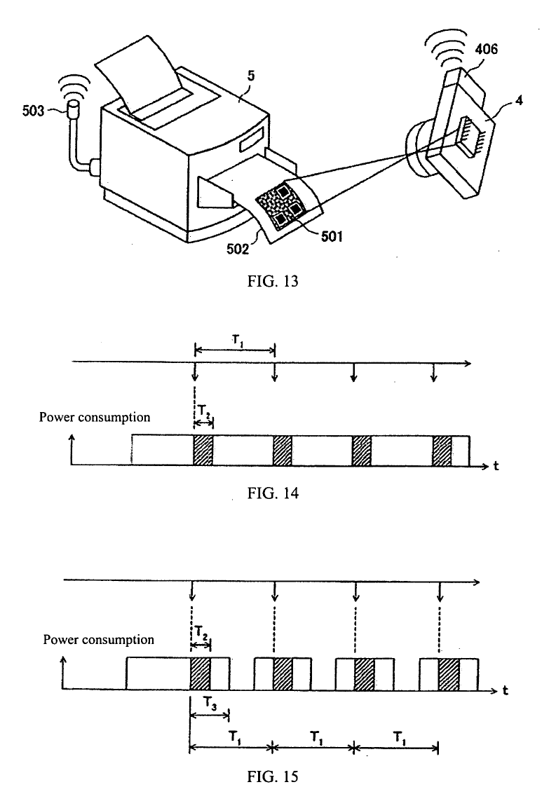

FIG. 13 is a diagram illustrating an example of connection of a printer and a DSC using a wireless LAN in Embodiment 6 of the invention. FIG. 13 shows DSC 4, antenna 406 for the wireless LAN, printer 5, image pattern 501, paper 502 having image pattern 501 printed on it, and antenna 503 for the wireless LAN. The same keys are adopted in FIGS. 1, 5 and 13. Such printer 5 has a wireless LAN function, and, just like DTV 3 in Embodiment 1, printer 5 converts the connection information of the wireless LAN to image pattern 501. Here, different from the first embodiment, on printer 5, generated image pattern 501 is printed on paper 502. The printed image pattern 501 is taken by DSC 4, and the connection information is acquired by converting image pattern 501. With this connection information, the wireless LAN function is set, and wireless LAN connection is made between DSC 4 and printer 5.

As image pattern 501 can be printed on paper 502 for storage, and once printed, it also can be used in the next round. Also, when the wireless LAN is shared with other devices, in consideration of security, as in Embodiment 5, refresh may occur each time that image pattern 501 is printed on paper 502.

In the case of the printer, it is possible to increase the precision of image pattern 501. Consequently, it is possible to contain a large amount of information. In addition to the SSID and WEP key and other information for connection to the wireless LAN, information pertaining to the operating conditions of the printer, such as the speed, the capacity of the buffer memory, etc. of the printer, may also be contained in image pattern 501. Consequently, it is possible to select the connection state to the wireless LAN on the side of DSC 4. For example, if printer 5 has a low speed, this state is transmitted to DSC 4, so that connection to the wireless LAN is intermittent, and it is possible to lower the power consumption. Also, if printer 5 has a very large buffer memory, DSC 4 can transmit the image in a single round of operation, and it is possible to complete the connection to the wireless LAN in a short period of time so that power can be conserved. If the capacity of the buffer memory is small, from the relationship between the capacity of the buffer memory and the speed, a portion of the image can be quickly sent at high speed, and the connection of DSC 4 to the wireless LAN can be cut until printing has been completed. Consequently, it is possible to reduce the power consumption of DSC 4.

FIG. 14 is a graph illustrating the power consumption needed for connection of a DSC to a wireless LAN when there is no information in the DSC pertaining to the operating condition of the printer. Transfer of an image from DSC 4 to printer 5 is performed upon a request from the printer. Because printer 5 cannot detect whether there will be a later request, DSC 4 must always be kept in the reception state. The image transfer interval is T₁, but the actual transmission is performed only for time T₂ from the time of request from printer 5. In this case, power is wasted in the period of T₁-T₂ when an image is not transferred.

FIG. 15 is a graph illustrating the power consumption needed for connection of a DSC to a wireless LAN when the DSC has information pertaining to the operating condition of the printer. FIG. 15 shows a case when image pattern 501 is used to add information for use in connection to the wireless LAN to DSC 4 from printer 5, and information pertaining to the operating condition of printer 5 is also transmitted. For DSC 4, since the information of the buffer memory of printer 5 is known, printer 5 can detect time T₁ expected for sending of the next request. Consequently, it is possible for image transmission time T₂ and wireless LAN operating time T₃ to approach each other, and it is possible to reduce the power consumption needed for connection to the wireless LAN.

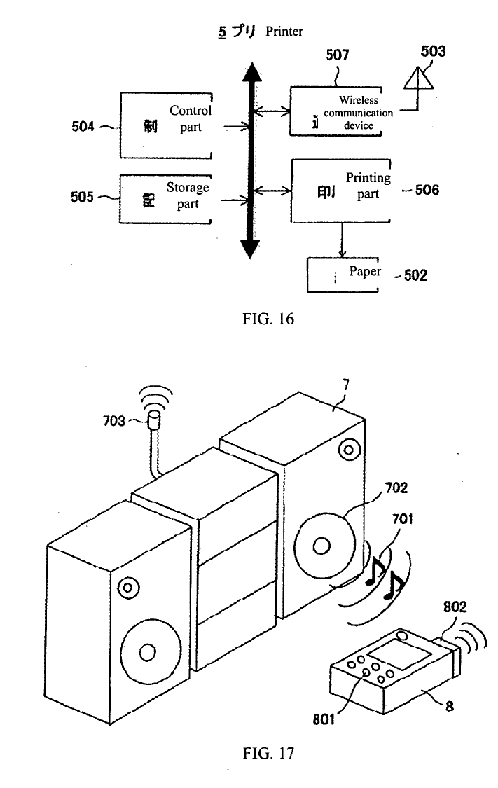

FIG. 16 is a block diagram illustrating an example of the configuration of a printer. Such printer 5 has antenna 503 for a wireless LAN, control part 504, recording part 505, printing part 506, and wireless communication part 507. Also, FIG. 16 shows paper 502 printed by printing part 506. The same keys are adopted in FIGS. 13 and 16.

Such control part 504 has a CPU and memory not shown in the figure. Such control part 504 retrieves the SSID and WEP key and other connection information stored in wireless communication part 507, and the connection information is converted to image pattern 501. Also, control part 504 controls printing part 506, wireless communication part 507 and other hardware. For example, recording part 505 may be formed from a hard disk, flash memory, or the like, and it allows rewrite.

For example, storage part 505 is made of a hard disk, flash memory, or the like, and it allows rewrite. In storage part 505, a program for converting the connection information to voice pattern 501 and information pertaining to the operating condition of the printer, such as the speed and buffer memory, etc. of the printer, is stored.

Such printing part 506 is controlled by control part 504, and image pattern 501 is printed on paper 502. Also, for wireless communication part 507, antenna 503 is connected, and it is used for connection to the wireless LAN.

Here, control part 504 is an example of the first control part of the invention, storage part 505 is an example of the storage part of the invention, printing part 506 is an example of the output part of the invention, and wireless communication part 507 is an example of the first wireless communication part of the invention.

FIG. 17 is a diagram illustrating an example of transmission of connection information using the voice pattern pertaining to Embodiment 7 of the invention. FIG. 17 shows voice output device 7, voice pattern 701, speaker 702, antenna 703 for a wireless LAN, voice recording device 8, microphone 801, and antenna 802 for a wireless LAN. In such Embodiments 1-6, image pattern 301 is used to send the SSID and WEP key and other connection information. In the present embodiment, voice pattern 701 is used to send the connection information.

Music data server or another voice output device 7 is connected to a wireless LAN, and there is speaker 702. Also, a portable player or another voice recording device 8 has microphone 801 for voice recording. Connection information is sent from voice output device 7 to voice recording device 8 by means of voice pattern 701. As the method for converting the connection information to voice pattern 701, one may adopt a method in which a telephone modem is used. Such voice output device 7 converts the connection information to voice pattern 701, and the voice is emitted from speaker 702. In this case, if the volume were too high, it would be painful to the ears of the user. Here, since voice recording device 8 can be set near voice output device 7, there is no special need to raise the volume. Such voice recording device 8 uses microphone 801 for voice recording to receive voice pattern 701, which is re-converted to the connection information, so the connection information is retrieved. Based on the retrieved connection information, association with the wireless LAN occurs. After association with a voice-less LAN, for the network protocol, image pattern 301 is used just as in the other embodiments.

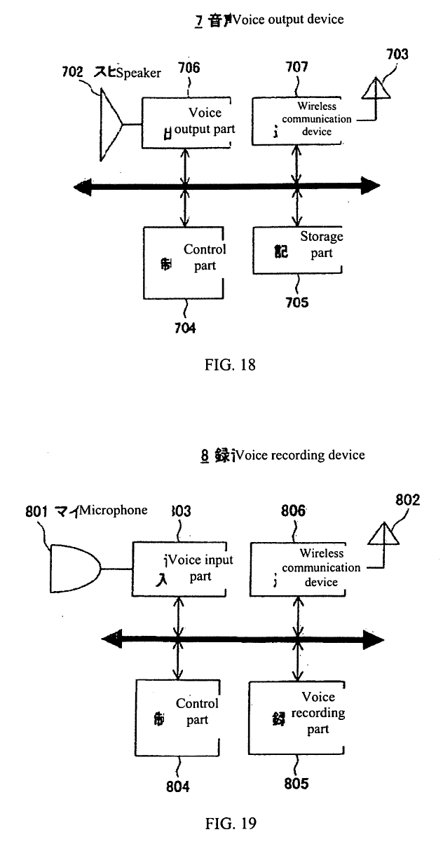

FIG. 18 is a block diagram illustrating an example of the configuration of a voice output device. Such voice output device 7 has speaker 702, antenna 703 for a wireless LAN, control part 704, recording part 705, voice output part 706, and wireless communication part 707. Here, voice output device 7 has a CD-ROM, MD or other driving part not shown in the figure.

Such control part 704 has a CPU and memory not shown in the figure. Such control part 704 converts the connection information to voice pattern 701, and it controls voice output part 706, wireless communication part 707, and other hardware.

For example, storage part 705 is made of a hard disk, flash memory or the like, and it allows rewrite. In storage part 705, a program for converting the connection information to voice pattern 701 and voice data, etc. are stored.

Such voice output part 706 converts the voice data from a digital signal to an analog signal, and it drives speaker 702. Also, wireless communication part 707 has connected antenna 703, and it is used in connection with a wireless LAN.

Here, control part 704 is an example of the first control part of the invention, speaker 702 is an example of the output part of the invention, and wireless communication part 707 is an example of the first wireless communication part of the invention.

FIG. 19 is a block diagram illustrating an example of the configuration of a voice recording device. Here, voice recording device 8 has microphone 801, antenna 802 for a wireless LAN, voice input part 803, control part 804, voice recording part 805, and wireless communication part 806.

Such voice input part 803 converts the voice of an analog signal input from microphone 801 to voice data of a digital signal. Such voice recording part 805 is made of a flash memory, a hard disk or the like, and it allows rewrite. It has voice data or the like recorded on it.

Such control part 804 has a CPU and memory not shown in the figure. Such control part 804 performs re-conversion for the SSID and WEP key and other connection information for voice pattern 701. Also, voice input part 803 and wireless communication part 806 or other hardware is controlled. Such wireless communication part 806 has antenna 802 for wireless LAN connection, and it is used for connection with a wireless LAN.

Here, voice input part 803 is an example of the input part of the invention, control part 804 is an example of the second control part of the invention, and wireless communication part 806 is an example of the second wireless communication part of the invention.

As explained above, according to Embodiments 1-7, the connection information needed for connection to a wireless LAN, such as IEEE802.11a/b/g, Bluetooth, UWB, etc. Consequently, it is possible to realize setting of a connection to a wireless LAN of a wireless communication device in a very simple way in a very short time.

In Embodiments 1-4, a display is used to display an image so as to display an image pattern, or an image pickup element for taking pictures is used in an image pickup operation. Consequently, there is no need to use new hardware. In addition, even if plural DTVs are present, it is still easy for the user to select the DTV image to be taken. Consequently, when different connection information types are to be displayed on plural DTVs, the user can freely choose which connection information is to be used for connection to a wireless LAN.

According to Embodiment 5, because the connection information of the WEP key, etc. can be changed in a short period of time, it is possible to improve security. Consequently because connection setting to a wireless LAN can be easily and quickly performed, there is no need to construct a temporary wireless LAN configuration each time a wireless communication device is to be connected to the wireless LAN. In this way, it is possible to further improve security.

According to Embodiment 6, information pertaining to the operating condition of the printer is contained in the image pattern, so DSC can be connected intermittently to the wireless LAN, and it is possible to reduce the power consumption of the DSC.

According to Embodiment 7, a speaker that outputs a normal voice for output of a voice pattern, and a microphone for input of a normal voice is used, so there is no need to use new hardware.

Those skilled in the art to which the invention relates will appreciate that the foregoing are merely representative example implementations, and that there are many other ways and variations of ways for implementing the principles of the invention, within the scope of the claims.

What is claimed is:

1. A wireless communication system, comprising:
an output device, including:
a first wireless communication part that stores the connection information shared by devices that perform wireless communication and performs wireless communication based on the connection information;
a first control part that converts the connection information to a connection information pattern of voice and/or image; and
an output part that outputs such connection information pattern;
and an input device, including:
an input part that inputs voice and/or image;
a second control part that analyzes such input voice and/or image and, when it is judged that such input voice and/or image may be the connection information pattern, re-converts such connection information pattern to a connection information candidate; and
a second wireless communication part that performs test wireless communication based on such connection information candidate.

2. The wireless communication system of claim 1, further comprising:
a wireless network access device that performs the following operation:
the wireless communication emitted from such output device is received;
when it is determined that the received wireless communication has been performed based on such connection information, such output device is connected to the wireless network, and a test wireless communication of such input device is received; and
when it is determined that such received wireless communication has been performed based on such connection information, such input device is connected to the wireless network.

3. The wireless communication system of claim 1, wherein such output device receives the test wireless communication of such input device; and, when it is determined that the received wireless communication has been performed based on such connection information, wireless communication is performed with such input device.

4. The wireless communication system of claim 3, wherein, at a prescribed timing, such first control part refreshes such connection information, sets such refreshed connection information in such first wireless communication part, and converts such refreshed connection information to the connection information pattern.

5. The wireless communication system of claim 1, wherein such connection information comprises a wireless communication standard on which the device for performing such wireless communication is based.

6. The wireless communication system of claim 1, wherein such connection information comprises an SSID and WEP key.

7. The wireless communication system of claim 1, wherein such connection information comprises an IP address of such output device.

8. The wireless communication system of claim 1, wherein such output device is a digital television receiver; such connection information pattern is an image pattern; and such input device is an image pickup device.

9. The wireless communication system of claim 1, wherein such output device is a printer; such connection information pattern is an image pattern; and such input device is an image pickup device.

10. The wireless communication system of claim 9, wherein such printer has a storage part that stores the operating condition; and such image pattern also contains the operating condition of such printer.

11. The wireless communication system of claim 8, wherein such connection information is represented by the shape, color, and/or pattern of such image pattern.

12. The wireless communication system of claim 10, wherein such image pattern is a two-dimensional code.

13. An output device for performing wireless communication with other wireless communication devices based on connection information shared by devices that perform wireless communication, the output device comprising:
a wireless communication part that stores such connection information and performs wireless communication based on such connection information;
a control part that converts such connection information to a connection information pattern of voice and/or image; and
an output part that outputs such connection information pattern.

14. An input device for performing wireless communication with other wireless communication devices based on the connection information shared by devices that perform wireless communication, the input device comprising:
an input part that inputs voice and/or image;
a control part, which analyzes such input voice and/or image, and, when it is judged that such input voice and/or image may be a connection information pattern, re-converts such connection information pattern to a connection information candidate; and
a wireless communication part that performs test wireless communication based on such connection information candidate.

15. A wireless communication method in a system having any output device that performs wireless communication with other wireless communication devices based on a connection information shared by devices that perform wireless communication, and having an input device that performs wireless communication with other wireless communication devices based on such connection information; the method comprising:
using the output device:
converting such connection information stored in such output device to a connection information pattern of voice and/or image; and
outputting such connection information pattern, and performing wireless communication based on such connection information;
and using the input device:
receiving voice and/or image input;
analyzing the input voice and/or image;
when it is determined that such input voice and/or image may be the connection information pattern, re-converting such connection information pattern to a connection information candidate; and
performing test wireless communication based on such connection information candidate.
